(19) United States
(12) Patent Application Publication
(10) Pub. No.: US 2003/0094189 A1
(43) Pub. Date: May 22, 2003

(54) Multi-functional umbrella holder

(76) Inventor: Chin Sung Ko, Changhua Shien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/988,428

(22) Filed: Nov. 20, 2001

(51) Int. Cl. A45B 3/00; A45B 5/00; A47G 29/00; F16M 11/00

(52) U.S. Cl. 135/16; 248/688

(57) ABSTRACT

The present invention relates to a multi-functional umbrella holder of a folded umbrella. The holder includes an upper connecting ring and a bottom base to engage with an inner moveable connector respectively. The folded umbrella has its shaft connected with the connector and it can be completely received in the holder to become a simple tubular structure for easy carrying and storage.

### BACKGROUND OF THE INVENTION

A folded umbrella is designed for convenient carrying and storage. Most improvement of prior art is to change the folded length of the umbrella. Furthermore, in order to keep the cover of the umbrella in order, an affixed umbrella receiver is provided to receive the folded umbrella. But this design can not provide for utility. The said receiver is always lost at a time of use. If the umbrella is used in a rainy day, this folded umbrella still can not be put inside a bag since the rain remains on the umbrella. So the prior folded umbrella is not convenient for carrying and storage in deed.

Accordingly, the primary object of the invention is to provide a multi-functional umbrella holder, which can directly receive the umbrella for user in carrying or storage of the umbrella. Now the features and advantages of the present invention will be described in detail with reference to the accompanying drawings.

### BRIEF DESCRIPTION OF ACCOMPANYING DRAWINGS

FIG. 1 is an exploded perspective view showing a multi-functional umbrella holder according to the present invention.

FIG. 2 is a plan view showing a folded umbrella having a multi-functional umbrella holder in opening state according to the present invention.

FIG. 3 is a plan view showing a folded umbrella having a multi-functional umbrella holder in closing state according to the present invention.

FIG. 4 is a cross-sectional view of FIG. 2 alone line A-A of FIG. 5.

FIG. 5 is a top view of FIG. 3.

FIG. 6 is a cross-sectional view of FIG. 3 alone line A-A of FIG. 5.

FIG. 7 is a cross-sectional view being similar to FIG. 6 showing another embodiment according to the present invention.

### DETAILED DESCRIPTION OF PREFERRED EMBODIMENTS

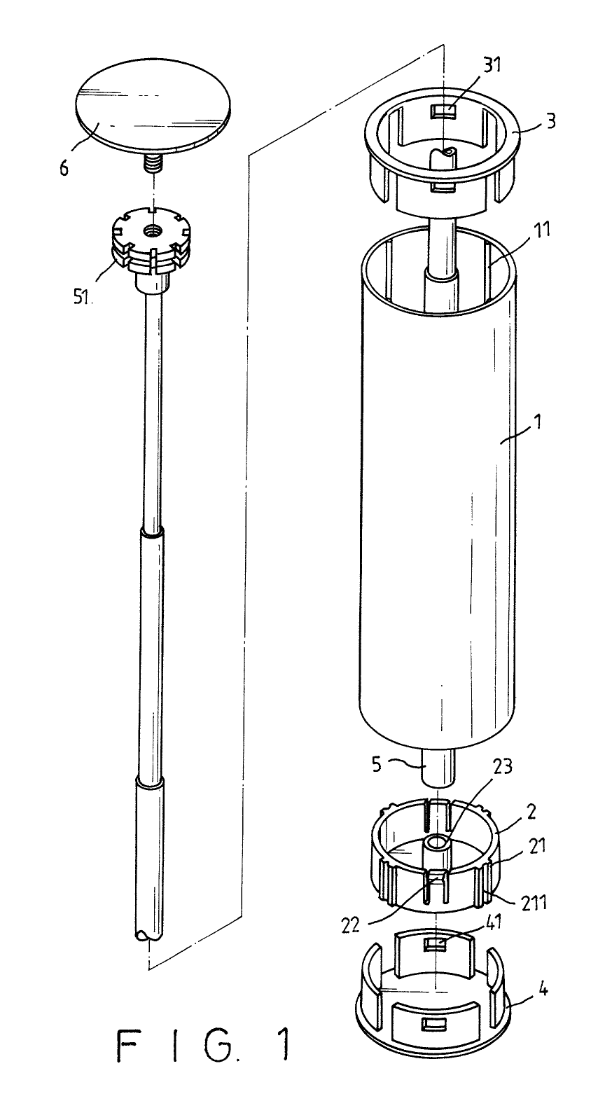

Please firstly refer to FIGS. 1 to 3, the present invention relates to an improvement of a folded umbrella with a multi-functional holder, which is a tubular umbrella holder (1). The holder (1) is formed with several axial guides (11) in its inner wall. A connector (2) is provided in the holder (1), which has several projections (21) with a central groove (211) outside while each guide (11) is slidable in a related groove (211). So the connector (2) is capable of sliding in the holder (1). A connecting ring (3) with two opposite holes (31) is provided at topside of the holder (1). A base (4) with two opposite holes (41) is tightly connected at bottom of the holder (1). The said connector (2) is formed with two opposite elastic hooks (22), each of which can be engaged with a related hole (31) of the connecting ring (3) or a hole (41) of the base (4) during movement in the holder (1) to obtain a stable position. A rod (23) is formed on the connector (2) for connecting with bottom of a shaft (5) of a folded umbrella having an upper joint (51), a runner (52), and an umbrella frame (53) with cover thereon as a prior one. A cap (6) is provided on the upper joint (51).

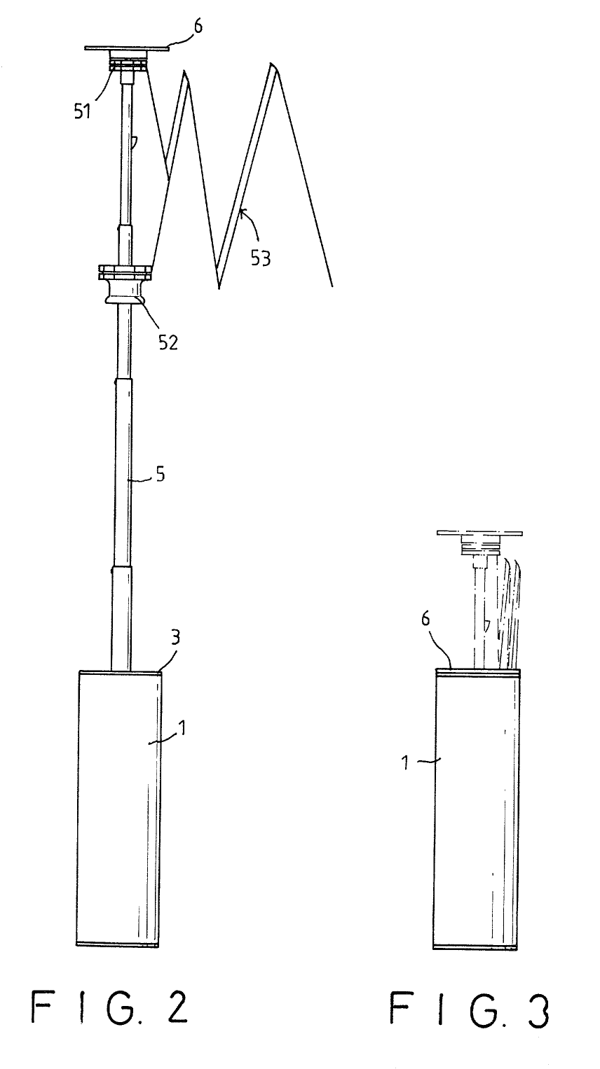

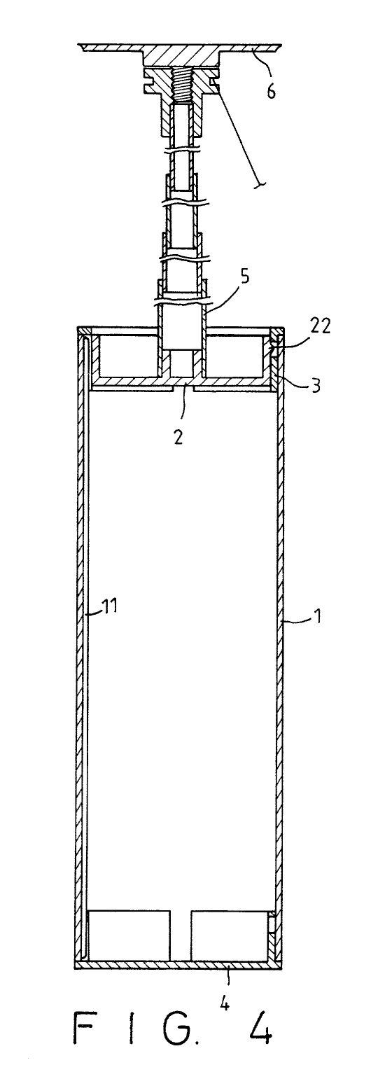

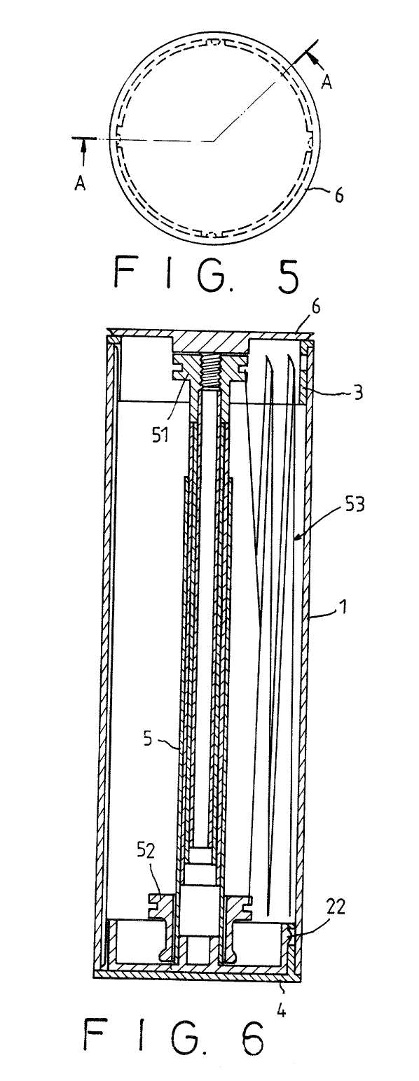

In use, the folded umbrella is opened as in FIGS. 2 and 4, while the connector (2) is fixed on the connecting ring (3). The holder (1) can be easily held by user and the total length of the umbrella is increased. When to close the umbrella, the shaft (5) and the frame (53) are capable of being received in the holder (1), as shown in FIGS. 3, 5, and 6. The cap (6) is then to seal the holder (1) while the connector (2) is positioned at the base (4).

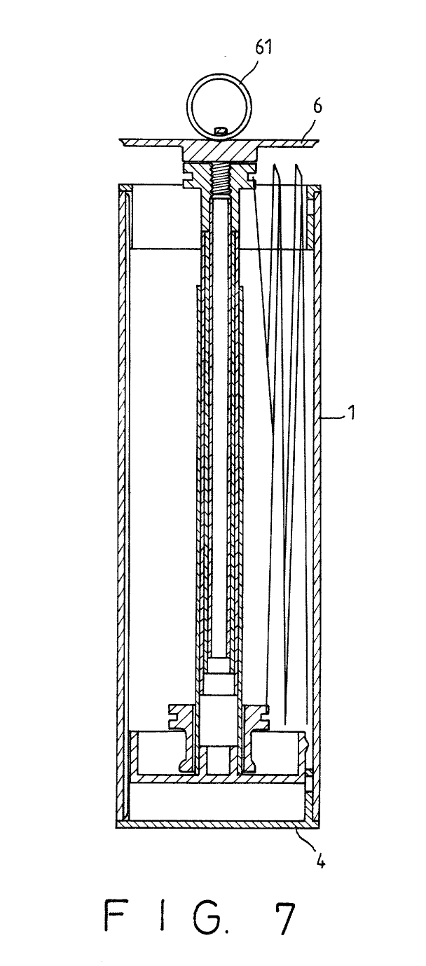

It is to be understood that the holder (1) of the present invention can be used for increasing the total length of the umbrella as in use. It can also be used as a receiver to receive the folded umbrella to become a simple tube for easy carrying and storage. Furthermore, the holder can be sealed by the base and the cap that keeps the wet umbrella being received therein and the dry holder can be stored anywhere without wetting others in a bag of the user. As shown in FIG. 7, a ring (61) is provided on the cap (6) for convenient pulling of the umbrella for use.

Accordingly, the present invention provides an invented structure with improved utility. It obviously gains the utility and novelty for patent and is thus applied.

What is claimed is:

1. A multi-functional umbrella holder including a tubular holder, an upper connecting ring, and a bottom base, a connector being provided in the holder and being slidable with two stable engaged position relating to the holder, and having a rod to connect with a shaft of a folded umbrella including an upper joint, a runner, and a frame with cover thereon while a cap is formed on the upper joint.

2. The multi-functional umbrella holder as claimed in claim 1, wherein the connector being fixed on the connecting ring while the folded is used and the holder is conveniently to be held and the total length is increased; the connector being positioned at the base while the umbrella is closed and folded, and the folded can be received in the holder and sealed by the cap.

3. The multi-functional umbrella holder as claimed in claim 1, wherein the holder can be tubular, oval, or multangular.

4. The multi-functional umbrella holder as claimed in claim 1, wherein the holder is formed with inner axial guides and the connector is formed with related project having groove for guiding the connector to move in the holder.

5. The multi-functional umbrella holder as claimed in claim 1, wherein the connecting ring and the base are provided with holes and the connector is provided with related elastic hook for elastic engaging the connector with the connecting ring or the base.

6. The multi-functional umbrella holder as claimed in claim 1, wherein a ring is formed on the cap.
